(19) United States
(12) Patent Application Publication
(10) Pub. No.: US 2010/0120401 A1
(43) Pub. Date: May 13, 2010

(54) AUTOMATIC CONTACT INFORMATION ENTRY VIA LOCATION SENSING

(76) Inventor: Mark Gilmore Mears, Zionsville, IN (US)

Correspondence Address: Robert D. Shedd, Patent Operations;THOMSON Licensing LLC, P.O. Box 5312, Princeton, NJ, 08543-5312, US

(21) Appl. No.: 12/452,025

(22) PCT Filed: Jun. 27, 2007
(86) PCT No.: PCT/US2007/014960

§ 371 Date: Dec. 11, 2009

(51) Int. Cl. H04W 4/02; G06F 17/30

(52) U.S. Cl. 455/414.1; 707/769; 707/E17.108

(57) ABSTRACT

A method for entering contact information into a mobile computing device using location sensing of the mobile device is provided. Upon entry of the auto-fill mode (12) via a setup menu or mode in the mobile computing device, the device's location is determined (14). Once the location of the device is determined, the user is provided with one or more possible contacts based on the mobile device's location coordinates (24). The user can select from the list and save the selected contact, or may request any one of several options. For example, the user may select a contact and request to edit it (34) after it has been initially saved. The user may opt not to select one of the contacts from the list and request an additional attempt by the system. It is further possible the system will not provide any possible contacts to the user, in which case the user can manually enter the contact (10, 12) or quit the auto-fill mode.

### FIELD OF TECHNOLOGY

The present invention relates to mobile communication devices. More particularly, it relates to the automatic entry of contact information for a mobile communication device.

### BACKGROUND OF THE INVENTION

When using a mobile device, the entering of all your friends, family and business information into the device can be boring, tedious and slow. For example, when using a “cell phone entry method”, the user may have press the “7” key four times just to get the letter “S” to appear. For a personal digital assistant (PDA), the stylus is pecked at a screen one character at a time.

Other manual entry methods for a users contact list are also available and usually require the input of data directly by the user in one form or another (e.g., by typing, writing, using text message keys on a mobile device, etc.) which may either be difficult because of the size of the input means or time consuming.

### SUMMARY OF THE INVENTION

It is therefore an aspect of the present principles to provide a method for the automatic phone and address contact information entry into a mobile device, such as, for example a cell phone or PDA.

This and other aspect are achieved in accordance with an implementation of the present principles wherein the method for entering contact information into a mobile computing device includes selecting an auto fill mode of operation for the mobile device, determining the location of the mobile device, matching the mobile device location to information relating to at least one contact from a database corresponding to the device location, sending the information relating to at least one contact possibility to the mobile device, and requesting user action in response to the information relating to the at least one contact possibility received at the mobile device.

The requesting of user action can include, for example, determining whether multiple contact possibilities exist for the determined location of the mobile device, displaying a list of multiple contact possibilities to the user when more than one contact possibility exists, and requesting user input to select one or none of the multiple contact possibilities.

In order to determine the location of the mobile device, various methods can be implemented. For example, the mobile device location can be obtained using tower triangulation techniques, or alternatively, utilizing a GPS receiver built into the mobile device.

When using the GPS of the mobile device, the location determination can include, obtaining GPS coordinates from the built in GPS receiver, determining whether contact information is stored for the obtained coordinates, and sending the GPS coordinates to a network provider when no contact information is stored for the obtained coordinates.

When contact information is stored for the obtained coordinates, the user is informed accordingly, and the GPS coordinates are sent to a network provider when the user selects to proceed regardless of the stored contact information.

Other aspects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is flow diagram of the method for automatic contact information entry according to an implementation of the present principles;

FIG. 2 is a flow diagram of the method for automatic contact information entry according to another implementation of the present principles; and

FIG. 3 shows a block diagram of a mobile computing device according to an implementation of the present principles.

### DETAILED DESCRIPTION

It is a common feature for cell phones or other mobile computing devices to have the ability to sense its location via cell phone tower triangulation. This is the case, at a minimum, for 911 emergency services, but also for more enhanced service offerings like pulling or pushing information regarding businesses in the immediate area. More advanced cell phones and mobile computing devices have global positioning system (GPS) receiver built in or integrated therewith.

In accordance with one implementation of the present principles, rather than laboriously typing in a favorite person's or business's contact information (e.g., contact name, phone number and/or address), the user can go to the contacts feature in their personal mobile device and select “Auto-fill contact info by location”. In response, the mobile device will detect its current location (e.g., either by GPS receiver built in, cell phone tower triangulation or any other method for location sensing). The location information of the mobile device (e.g., coordinates) is sent to the network provider, which correlates the location coordinates to one or more contacts identified in the user's location. The contact information can include specific names, phone numbers and/or complete addresses which are then sent to the user's mobile device.

In the event multiple entries are found for the same location (e.g., Jim Smith, 102 Main St. 317-888-2222, etc.; Jane Ryan, 103 Main St., etc; Bob Tipp, 108 Main St., etc.), each is presented to the user whereupon the user may select the “right” entry from the list, which is then stored in the user's mobile device. Any unselected options are discarded.

The display of the multiple entries to the user can take many different forms. For example, the user may be presented with either a list of names, addresses and/or phone numbers, or any combination of the same. Once stored, the user can edit the stored contact information as they desire.

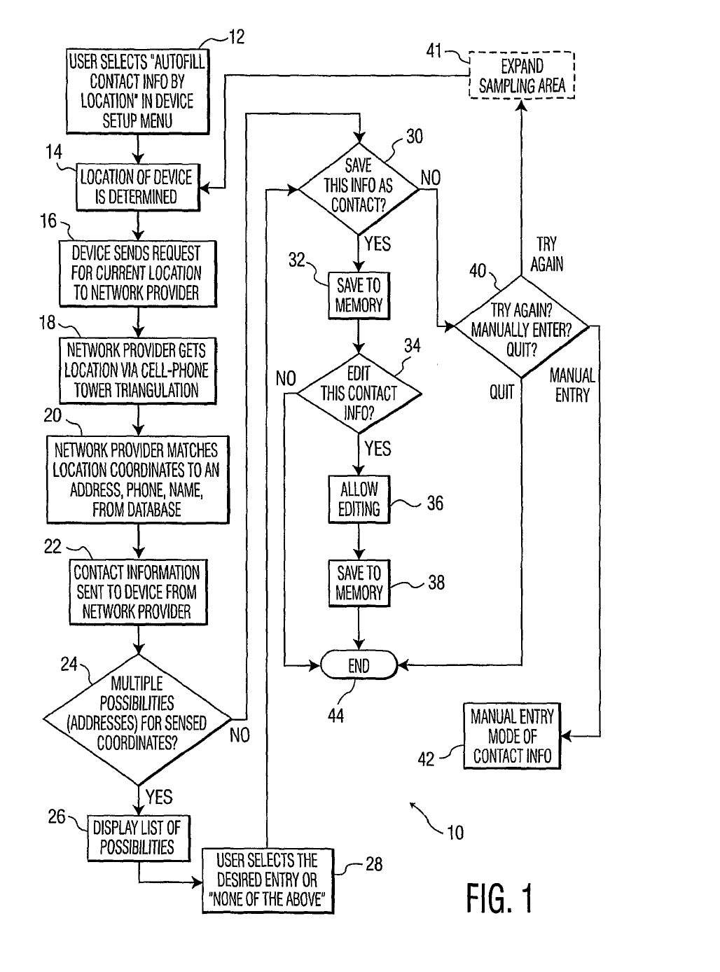

FIG. 1 shows a flow diagram 10 according to an aspect of the present principles. Initially, the user selects an option 12 called “auto-fill contact by location” on their mobile device. This option may be called other things and would ordinarily be contained in the mobile device setup menu or possibly the contact menu as an option. Once the “auto-fill” option is initiated, the mobile device determines its location 14. In this embodiment, the location determination 14 is performed by the mobile device sending a request for the current location to a network provider 16, and the network provider obtaining the location using cell phone tower triangulation 18. The network provider then matches the location coordinates to an address, phone number, and/or name from a database 20. Once matched, the network provider sends the mobile device the contact information 22.

In the practice of the invention, database 20 may be a relational database available through a network such as the Internet, which contains information that maps GPS information to name, address, and other identifying information for a user. In an optional embodiment of the present invention, database 20 may be pre-selected by a user so that a database provided by a first supplier of information may be chosen over a second supplier of information. Additionally, a user may specify that once the name and address information is returned from a first database 20, that such information (or other types of personal information) is submitted to a second database 20 as a search query. That way, a user can get supplemental information (such as personal web pages or electronic logs that the person may maintain, information about their occupation, information about their spouse and children, and the like) which are not name, address, and phone information.

This concept can be expanded so that a search may be transmitted to a specific vendor to establish whether the party identified through GPS information has different items that they may want to purchase. For example, once a person's identifying information is discovered, a search query is transmitted to a database 20 to inquire about whether the identified party has anything on a wishlist or registry (such as a bridal registry) that they desire to be purchased on their behalf. The person operating the mobile device may then elect to learn about and/or purchase such items from a third party via a network connection. In the present example, a search query is automatically transmitted to Amazon (upon a user actuated command), where a user can list their various wishlist items. The user operating the mobile device then can use the services available through Amazon to purchase items for the identified party.

When providing the contact information to the user based on location, it is possible that more than one possible contact is obtained from the location information. As such, when the network provider sends the mobile device the contact information, there may be multiple possibilities sensed for those coordinates 24. When there are multiple possibilities sensed for the coordinates, the lists of possibilities are displayed 26 to the user of using an interface means such as a pop up window, or other type visual indication and the user selects the desired entry or “none of the above” at step 28. Where there are no multiple possibilities for the sensed coordinates, or the user makes a selection at step 28, a decision is presented to the user to save this contact information 30. If the user selects “yes”, the contact information is saved to memory 32. At this stage the process could end without any further user input

In one implementation of the present principles, the user may be provided with the option to edit the contact info 34 when the command to save in memory 32 is executed. When the user does not select to edit the contact, the process ends 44. When the user does elect to edit the contact, editing is allowed 36, and the edited information is saved in memory 38 and the process ends.

In the event the user does not select to save the contact information at step 30, they are provided with three (3) options 40. The user may select to “try again”, in which case the process starts over at step 14 and the location determination. According to one implementation, when the user selects “try again” it could be after the user moves closer to the intended address. According to yet another implementation, when the user selects “try again” as step 40, the system can expand the sampling area 41 being used for the location determination 14. By expanding the sampling area, a wider area of physical addresses (i.e., locations) is sampled in an attempt to capture the “right” address. As would be expected, the previously suggested and user-rejected locations are not offered in subsequent “try again” attempts.

The user may select “manually enter” in which case the mobile device enters a manual entry mode 42, and the user proceeds to manually enter the contact information. The last option to the user is to “quit” in which case the process ends 44.

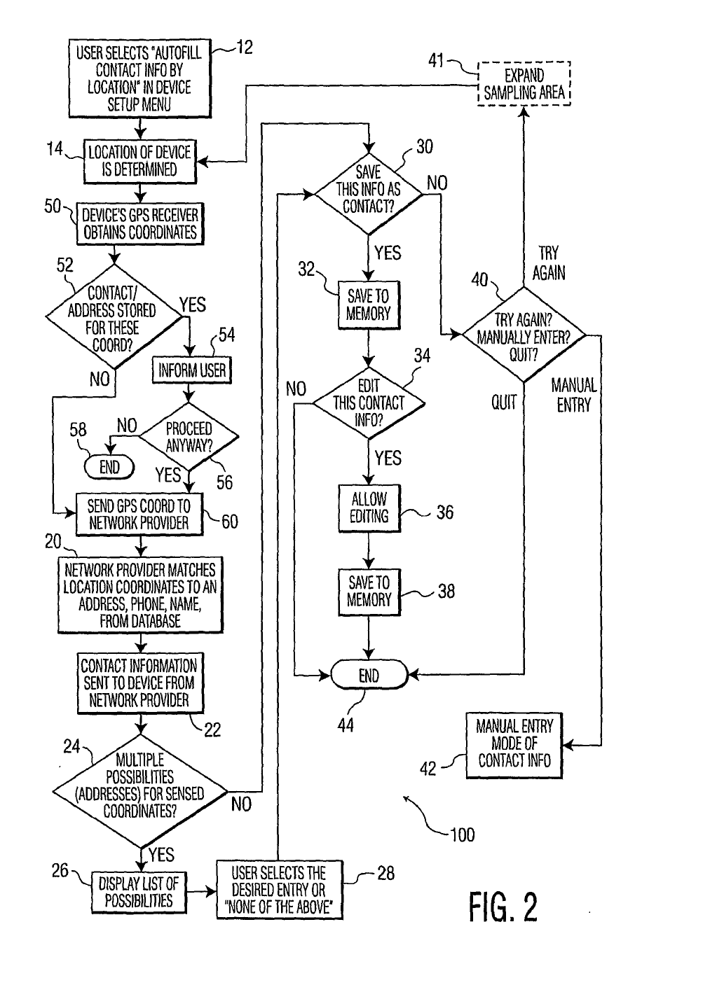

FIG. 2 shows another implementation of the method 100 according to the present principles. In this implementation, the location determination steps 16 and 18 of FIG. 1 are replaced with new steps 50-60. In order to determine the location of the device 14, the device utilizes its built in GPS receiver to obtain its coordinates 50. A determination is then made as to whether or not contact information is stored for these coordinates 52. If there is no contact information stored for these coordinates, the mobile device sends the GPS coordinates to the network provider 60.

When there is contact information stored for the coordinates of the mobile device, the user is informed 54 and asked whether or not to proceed anyway 56. If the user responds by saying “no” to the “proceed anyway” inquiry, the process ends 58 there. If the user responds by saying “yes” to the “proceed anyway” inquiry, the system proceeds to send the GPS coordinate information to the network provider 60.

The network provider matches the location coordinates to an address, phone number and/or name from a database. 20. The remaining steps preformed are identical to those described with reference to the implementation shown in FIG. 1, and will not be repeated.

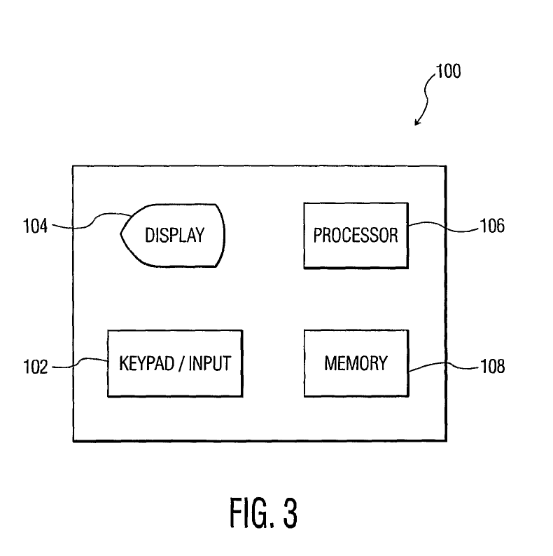

FIG. 3 shows a mobile computing device 100 having a keypad or other input 102, a display 104, a processor 106 and a memory 108. The keypad/input 102 can be any known input device, such as, for example a keypad, or a stylus (as used with a PDA). In other contemplated forms, display 104 can be a touch sensitive display and thereby eliminate the need for a separate keypad/input 102. The processor 106 is configured to perform all the standard functions of the mobile device 100 and memory 108 provides a storage area for the user's contact lists, and any other data the user may store on the mobile device. Those of ordinary skill in the art will recognize that memory 108 and its functions can be expanded into multiple memory modules, or can simply be configured to retain programming to perform the method steps of the present principles. Processor 106, in conjunction with any programming stored in memory 108, is configured to perform all the required functions of the methods of the present principles.

It is to be understood that the present principles may be implemented in various forms of hardware, software, firmware, special purpose processors, or a combination thereof. Preferably, the present principles may be implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present principles is programmed. Given the teachings herein, one of ordinary skill in the related art will be able to contemplate these and similar implementations or configurations of the present principles.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto.

1. A method for entering contact information into a mobile computing device comprising the steps of:
selecting an auto fill mode of operation for the mobile device;
determining a location of the mobile device;
transmitting said location information to a database for matching the mobile device location to information relating to at least one contact from a database corresponding to the device location;
receiving the information relating to at least one contact possibility to the mobile device; and
requesting user action in response to the information relating to the at least one contact possibility received at the mobile device.

2. The method of claim 1, wherein said determining the location of the mobile device comprises obtaining the mobile device location using tower triangulation techniques and sending a request from the mobile device to a network provider for current location information.

3. The method of claim 1, wherein said determining the location of the mobile device comprises utilizing a built in GPS receiver.

4. The method of claim 1, wherein said requesting further comprises:
determining whether multiple contact possibilities exist for the determined location of the mobile device;
displaying a list of multiple contact possibilities to the user when more than one contact possibility exists; and
requesting user input to select one or none of the multiple contact possibilities.

5. The method of claim 1, wherein said requesting further comprises:
determining whether multiple contact possibilities exist for the determined location of the mobile device; and
requesting user input to save a displayed contact when there are no determined multiple contact possibilities.

6. The method of claim 4, wherein said requesting further comprises:
requesting whether the user would like to save one of the multiple contact possibilities; and
saving a selected contact to a memory in response to the user's selection.

7. The method of claim 6, further comprising:
providing the user with an edit option for the selected contact after said saving step is performed.

8. The method of claim 4, further comprising:
requesting whether the user would like to save one of the multiple contact possibilities; and
requesting whether the user would like to quit, try again or manually enter the contact when the user decides that none of the displayed list of multiple contact possibilities are desired.

9. The method of claim 8, further comprising expanding a sampling area for said location determination when a user requests to “try again”.

10. (canceled)

11. The method of claim 3, wherein said determining the location further comprises:
obtaining GPS coordinates from the built in GPS receiver;
determining whether contact information is stored for the obtained coordinates; and
sending the GPS coordinates to a network provider when no contact information is stored for the obtained coordinates.

12. The method of claim 3, wherein said determining the location further comprises:
obtaining GPS coordinates from the built in GPS receiver;
determining whether contact information is stored for the obtained coordinates;
informing the user when there is contact information stored for the obtained coordinates; and
sending the GPS coordinates to a network provider when the user selects to proceed regardless of the stored contact information.

13. The method of claim h further comprising the steps of:
submitting said contact information to a second database as a search query; and
receiving additional information as a supplement to said contact information from said second database as a result of said search query.

14. A program storage device having an application program tangibly embodied thereon, the application program including instructions for performing at least the following:
selecting an auto fill mode of operation for the mobile device;
determining the location of the mobile device;
transmitting said location information to a database for matching the mobile device location to information relating to at least one contact from a database corresponding to the device location;
receiving the information relating to at least one contact possibility to the mobile device; and
requesting user action in response to the information relating to the at least one contact possibility received at the mobile device.

15. The program storage device of claim 14, wherein the application program further includes instructions for performing at least the following:
determining whether multiple contact possibilities exist for the determined location of the mobile device;
displaying a list of multiple contact possibilities to the user when more than one contact possibility exists; and
requesting user input to select one or none of the multiple contact possibilities.

16. The program storage device of claim 14, wherein the application program further includes instructions for performing at least the following:
determining whether multiple contact possibilities exist for the determined location of the mobile device; and
requesting user input to save a displayed contact when there are no determined multiple contact possibilities.

17. The program storage device of claim 15, wherein the application program further includes instructions for performing at least the following:
inquiring whether the user would like to save one of the multiple contact possibilities; and
saving a selected contact to a memory in response to the user's selection.

18. The program storage device of claim 15, wherein the application program further includes instructions for performing at least the following:
inquiring whether the user would like to save one of the multiple contact possibilities; and
inquiring whether the user would like to quit, try again or manually enter the contact when the user decides that none of the displayed list of multiple contact possibilities are desired.

19. The program storage device of claim 14, wherein the application program further includes instructions for performing at least the following:
obtaining GPS coordinates from a GPS receiver integrated into the mobile device;
determining whether contact information is stored for the obtained coordinates; and
sending the GPS coordinates to a network provider when no contact information is stored for the obtained coordinates.

20. The program storage device of claim 14, wherein the application program further includes instructions for performing at least the following:
obtaining GPS coordinates from a GPS receiver integrated into the mobile device;
determining whether contact information is stored for the obtained coordinates;
informing the user when there is contact information stored for the obtained coordinates; and
sending the GPS coordinates to a network provider when the user selects to proceed regardless of the stored contact information.
